(19) United States
(12) Patent Application Publication
(10) Pub. No.: US 2009/0198558 A1
(43) Pub. Date: Aug. 6, 2009

(54) METHOD AND SYSTEM FOR RECOMMENDING JOBSEEKERS TO RECRUITERS

(75) Inventors: Changsheng Chen, Castro Valley, CA (US); Chyr-Chong (Joseph) Ting, San Jose, CA (US); Adam Hyder, Los Altos, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO! INC., Sunnyvale, CA (US)

(21) Appl. No.: 12/025,610

(22) Filed: Feb. 4, 2008

(51) Int. Cl. G06Q 10/00

(52) U.S. Cl. 705/10

(57) ABSTRACT

A method of establishing affinities among jobseekers is disclosed. The method comprises monitoring jobseeker activity on a web site. The jobseekers are correlated by a job ID based on jobs for which a jobseeker applies or views. A list of job IDs is sorted, with corresponding jobseekers IDs of jobseekers who have applied for or viewed a job among the list of job IDs converted to integers and grouped by job ID. An affinity is determined among jobseekers in groups according to a formula and jobseekers having an affinity with another jobseeker greater than a predetermined value are displayed to a recruiter.

### CROSS-REFERENCE TO RELATED APPLICATIONS

This application is related to U.S. patent application Ser. No. 11/442,108, filed on May 25, 2006 and U.S. patent application Ser. No. 11/441,997, filed on May 25, 2006, the disclosures of which are incorporated by reference in their entirety.

### BACKGROUND

1. Field

This disclosure relates to systems and methods for recommending jobseekers and more particularly to recommendations of job jobseekers to recruiters based on associative affinities.

2. General Background

Various search engines are available to users who view, apply for, request, purchase, and subscribe to items offered on the World Wide Web and other information sharing infrastructures. In addition, the exponential growth of the number of items offered on the World Wide Web can frustrate and confuse users when attempting to locate a needed item.

In particular, jobseekers can be assisted if job listing services recommend relevant job listings that have been determined to have an affinity with jobs previously applied for by the jobseeker. By doing this, jobseekers, employers, and job listing services benefit. In addition, the employer can receive a greater number of jobseeker applications for a particular job. However, recruiters have a more difficult time determining qualified potential jobseekers from the job applicant pool because of the large ratio of recruiters to jobs available at any given time.

### SUMMARY

The present disclosure addresses the need for providing a larger selection of jobseekers for any particular job. In this disclosure, a method and system is described that provides recommendations to recruiters based in part upon job to job affinities and relationships identified between various job listings.

In one embodiment, a method of establishing affinities among jobseekers is disclosed. The method comprises: monitoring jobseeker activity, with respect to job listings displayed on a web site in response to a query by a jobseeker. The activities include jobs viewed by the jobseekers and jobs applied for by the jobseekers. Each jobseeker is assigned a jobseeker ID and where each jobseeker ID is correlated with a job ID in a database for each job the jobseeker views and does not apply for. From the database a list of job IDs is obtained and sorted by job ID with corresponding jobseeker IDs of jobseekers having applied for or viewed at least one job among the list of job IDs. The jobseeker IDs in the list are then converted to integers, subsequently grouping the list by job ID. For the grouped list the group in which each jobseeker is located is determined and an affinity among jobseekers is determined in the groups according to a formula. Jobseekers having an affinity score greater than a predetermined value are then displayed to a recruiter. The predetermined value may 0.5 or the value may be adjustable and determined by the recruiter.

In one embodiment, a method is disclosed for establishing affinities among jobseekers. The method comprises: monitoring jobseeker activity, with respect to job listings displayed on a website in response to a query by a jobseeker. The activities include jobs viewed by the jobseekers and jobs applied for by the jobseekers. Each jobseeker is assigned a jobseeker ID and where each jobseeker ID is correlated with a job ID in a database for each job the jobseeker either views or applies for. From the database a list of job IDs is obtained and sorted by job ID with corresponding jobseeker IDs of jobseekers having applied for or viewed at least one job among the list of job IDs. The jobseeker IDs in the list are then converted to integers, wherein the integers are positive for jobseekers having applied for the corresponding job and the integers are negative for jobseekers having only viewed the corresponding job. The integers in the list by job ID are then grouped by job ID. For the grouped list, the group in which each jobseeker is located is determined and an affinity is determined among jobseekers in the groups according to a formula. Jobseekers having an affinity score greater than a predetermined value are then displayed to a recruiter. The predetermined value may 0.5 or the value may be adjustable and determined by the recruiter.

In one embodiment, a method is disclosed for establishing affinities among jobseekers. The method comprises: monitoring jobseeker activity, with respect to job listings displayed on a website in response to a query by a jobseeker. The activities include jobs viewed by the jobseekers and jobs applied for by the jobseekers. Each jobseeker is assigned a jobseeker ID and where each jobseeker ID is correlated with a job ID in a database for each job the jobseeker either views or applies for. From the database a list of job IDs is obtained and sorted by job ID with corresponding jobseeker IDs of jobseekers having applied for or viewed at least one job among the list of job IDs. The jobseeker IDs in the list are then converted to integers, wherein the integers are positive for jobseekers having applied for the corresponding job and the integers are negative for jobseekers having only viewed the corresponding job. The integers in the list by job ID are then grouped by job ID, wherein a zero separates each group in the list. For the grouped list, the group is determined in which each jobseeker is located and an affinity is determined among jobseekers in the groups according to a formula. Jobseekers having an affinity score greater than a predetermined value are then displayed to a recruiter. The predetermined value may 0.5 or the value may be adjustable and determined by the recruiter.

### BRIEF DESCRIPTION OF THE DRAWINGS

FIG. 1 illustrates a system for determining and communicating jobseeker affinity.

FIG. 2 illustrates a block diagram of a computing device.

FIG. 3 illustrates a flow diagram of a process of determining similar jobseekers.

FIG. 4 illustrates a flow diagram for a process of determining jobseeker affinity between two jobseekers.

FIG. 5 illustrates a flow diagram for a process of determining jobseeker affinity among jobseekers.

### DETAILED DESCRIPTION

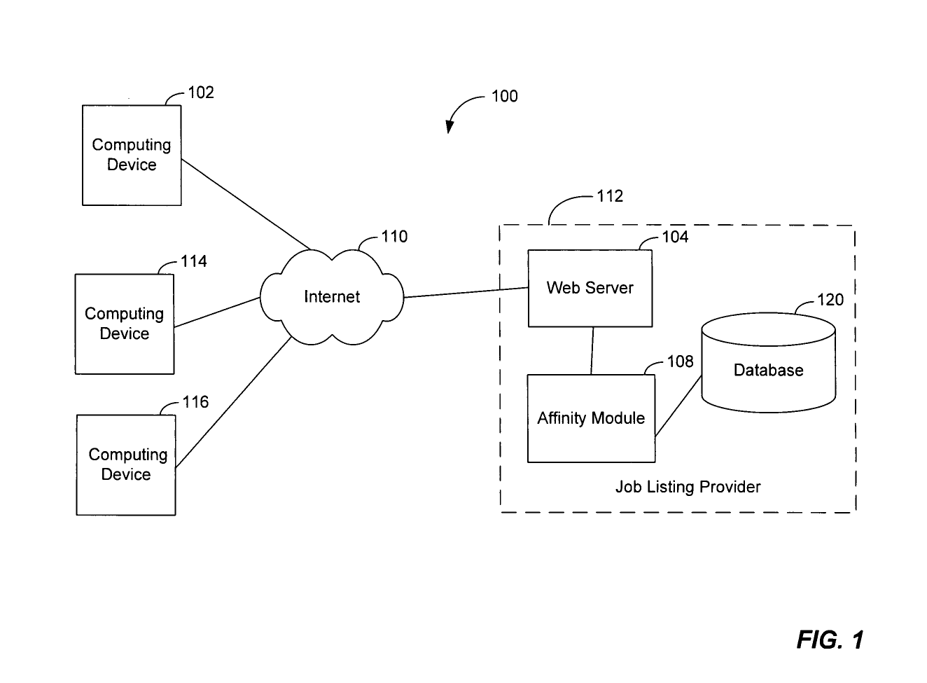

FIG. 1 illustrates a system for determining and communicating jobseeker affinity to a recruiter. A job recruiter can investigate potential job candidates by accessing a job listing provider 112 through computing devices 102, 114, and 116. The job listing provider 112 can be a job listing web site, a service provider, etc. The job listing provider 112 can be accessible by multiple recruiters who select, rate, view, or contact jobseekers regarding jobs provided or not provided by the job listing provider 112. One or more recruiters can communicate with the job listing provider 112 through the Internet 110 or any other communication network.

The job listing provider 112 can include a web server 104 that transmits and receives data messages with computing devices 102, 114, and 116. The computing devices 102, 114, and 116, and the web server 104 can utilize communication protocols such as HTTP. A database 120 can store recruiter profiles which, in turn, can include a record of jobseekers previously selected by the recruiter. The database 120 can also store recruiter preferences, industry information, job application patterns, interested resumes, etc.

The job listing provider 112 further includes affinity module 108 which can reside on a stand-alone computer. In another embodiment, the affinity module 108 resides in the server 104. The affinity module 108 may include logic to determine affinity between two jobseekers stored in the database 120. The affinity module 108 is further configured with logic to access, write and read data from the jobseeker database 120. Jobseeker affinity can then be utilized by the jobseeker affinity module 108 to formulate jobseeker recommendations and relay jobseeker recommendations to the recruiter. In another embodiment, a recommending module can be utilized to formulate recommendations based on jobseeker affinity.

As previously stated, the affinity module 108 can be configured to determine the affinity of jobseekers based on attributes of the jobseeker activity patterns.

In one embodiment, the affinity of two jobseekers can be represented by a similarity score s(Jobseeker 1, Jobseeker 2, Aᵢ), where Aᵢ is an attribute that Jobseeker 1 and Jobseeker 2 have in common. If the sum of the similarity score s(Jobseeker 1, Jobseeker 2, Aᵢ) is greater than a predetermined value, then Jobseeker 1 and Jobseeker 2 are affiliated. In one example, the value t can be between zero and one (e.g., 0<=t<=1). In another example, the value t can be a number within any other range. The value can be set by a system operator or administrator, or by a recruiter, or programmatically, or by some combination thereof. A total affinity score of two jobseeker listings can be calculated utilizing the similarity scores of all the attributes of Jobseeker 1 and Jobseeker 2.

In another embodiment, affinity A(Jobseeker 1, Jobseeker 2) of two jobseekers can be established by comparing each of attribute₁ . . . attribute_{N} of Jobseeker 1, with each of attribute₁ . . . attribute_{N} of Jobseeker 2. N is a fixed number of attributes utilized for comparison. In particular, each attribute of Jobseeker 1, in (attribute₁ . . . attribute_{N}), is compared to each attribute of Jobseeker 2, in (attribute₁ . . . attribute_{N}). In one embodiment, if Jobseeker 1 and Jobseeker 2 share an attributeᵢ, then that attribute similarity score is added to A(Jobseeker 1, Jobseeker 2). In another embodiment, if Jobseeker 1 and Jobseeker 2 share an attribute that is similar, based on a similarity table, then that attribute similarity score is added to A(Jobseeker 1, Jobseeker 2). In another embodiment, if Jobseeker 1 and Jobseeker 2 share an attributeᵢ in common, then a number with a value of one (or a weighted value) is added to A(Jobseeker 1, Jobseeker 2). Note that the score for each attribute can be weighted differently.

In another embodiment, the affinity A(Jobseeker 1, Jobseeker 2) is established as follows. Jobseeker 1 can have an attribute of a plurality of attributes, attribute₁ . . . attribute_{N}. In addition, attribute can have Nᵢ values. Jobseeker 2 also has an attributeᵢ of a plurality of attributes, attribute₁ . . . attribute_{N}, of Jobseeker 2 that may be in common with Jobseeker 1. In one embodiment, the affinity A(Jobseeker 1, Jobseeker 2) can be established according to the following formula: (N₁₂ᵢ/N₁ᵢ+N₁₂ᵢ/N₂ᵢ)/2. Where N₁₂ᵢ is the number of jobs that have attribute that both Jobseeker 1 and Jobseeker 2 selected, N₁ᵢ is the number of jobs that have attribute that Jobseeker 1 selected and N₂ᵢ is the number of jobs that have attribute that Jobseeker 2 selected. In another embodiment, the affinity A(Jobseeker 1, Jobseeker 2) can be established according to the following formula: (N₁₂₁/N₁₁+N₁₂₁/N₂₁)/2+ . . . +(N₁₂ᵢ/N₁ᵢ+N₁₂ᵢ/N₂ᵢ)/2.

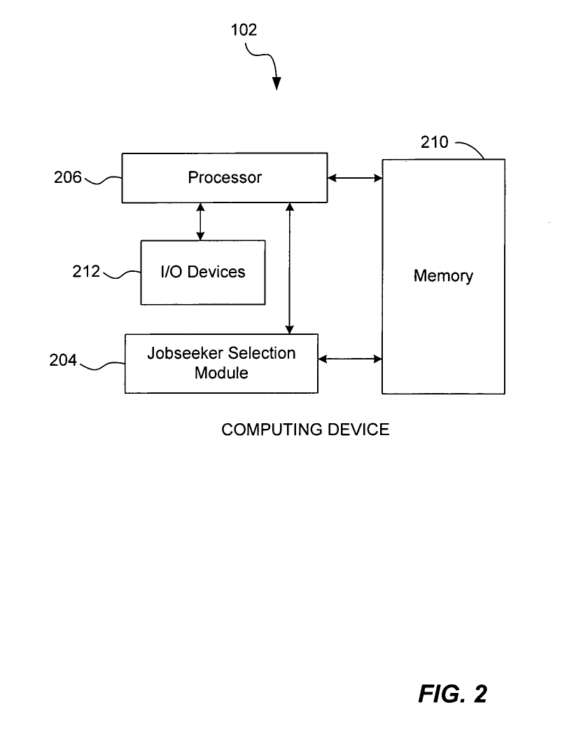

FIG. 2 illustrates a block diagram of an example of a computing device 102. Specifically, the computing device 102 may be employed by a recruiter to select jobseekers from the jobseeker listing provider 114, transmit recruiter information, or to receive affinity information. In one embodiment, the computing device 102 is implemented using a general-purpose computer or any other hardware or software equivalents. Thus, the computing device 102 generally comprises processor 206, memory 210, e.g., random access memory (RAM) and/or read only memory (ROM), jobseeker selection module 204, and various input/output devices 212, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the jobseeker selection module 204 may be implemented as one or more physical devices that are coupled to the processor 206 through a communication channel. Alternatively, the jobseeker selection module 204 may be represented by one or more software applications (or even a combination of software and hardware, e.g., using application specific integrated circuits (ASIC)), where the software is loaded from a storage medium, (e.g., a magnetic or optical drive or diskette) and operated by the processor 206 in the memory 210 of the computing device 102. As such, the jobseeker selection module 204 (including associated data structures) of the present disclosure may be stored on a computer readable medium, e.g., RAM memory, magnetic or optical drive or diskette and the like.

The jobseeker selection module 204 can be utilized by a recruiter to make jobseeker selections, such as matching a jobseeker from an Internet web site to a client for whom the jobseeker may be able to fill an employment position. In addition, the jobseeker selection module 204 can receive jobseeker affinity data from the server 104. The jobseeker selection module 204 can be configured to automatically make selection decisions based on affinity data and recommendations received from the server 104.

The jobseeker selection module 204 can be a computer application such as, by way of non-limiting example, an Internet browser or any other network communication software or hardware that permits a user to interact with the server 106.

In one embodiment, where the affinity of jobseekers is established independent of user interaction, the jobseeker selection module 204 is not essential because no user, such as a job recruiter, interaction is necessary to establish the affinity of two jobseekers. In another embodiment, the jobseeker selection module 204 provides jobseeker interaction data which can be utilized to establish jobseeker affinity based on the number of jobseekers that have selected a viewed or applied for a job.

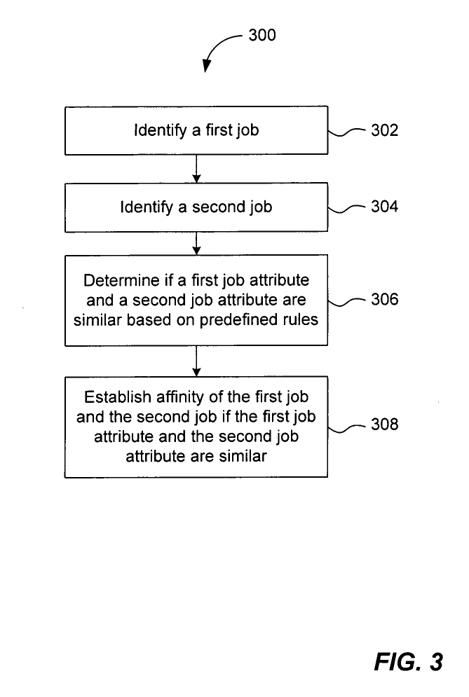

FIG. 3 illustrates a flow diagram of a process of determining jobseekers. At process block 302, a first jobseeker is identified. In one embodiment, the first jobseeker can be identified by accessing the jobseeker database 120. In addition, the jobseeker information, such as attributes, can also be stored in the database 120. The process 300 continues to process block 304.

At process block 304, a second jobseeker is identified. A second jobseeker can be also be retrieved from the database 120. In another example, the second jobseeker can be obtained from a new entry by the job listing provider 112. The process 300 continues to process block 306.

At process block 306, a similarity is determined between a first jobseeker attribute and a second jobseeker attribute. The similarity between two attributes can be determined utilizing predefined rules. In one example, a first jobseeker attribute and a second jobseeker attribute can be deemed similar only if the corresponding values are identical. For example, if the attribute is Location, the Location for a first and a second jobseeker is only similar if the location for both jobseekers is “Chicago.” In another embodiment, the first jobseeker attribute and the second jobseeker attribute can be deemed similar if there is a match of the first jobseeker attribute and the second jobseeker attribute in a predefined relational table. In another embodiment, the first and the second attributes are similar based on heuristic models implemented by a system administrator, jobseekers, recruiters, or programmatically. Two attribute values can be similar even when the attribute values are not identical. In one example, two locations can be deemed similar based on proximity. In another example, the predefined relational table can include locations that are similar even though the name of the location is not the same. Further, the table may indicate the level of similarity of the two attributes. For example, a location of San Francisco and a location of Berkley can have a higher similarity location than a location of San Francisco in comparison with San Jose.

Alternatively, the level of selection can be utilized to determine a similarity score. For example, if a jobseeker viewed a first job and a second job, a low similarity score is assumed for both jobs. If the jobseeker applied for both jobs, however, a higher similarity score for the two jobs can be assumed. In addition, the similarity score can then be utilized in the aggregate with other similarity scores of other users. Thus, if a high number of jobseekers applied for the same two jobs, there is a greater probability that the two jobs are closely related, which can be reflected in the sum of similarity scores. The process 300 continues to process block 308.

At process block 308, the first jobseeker and the second jobseeker are established to share affinity if the first jobseeker attribute and the second jobseeker attribute were determined to be similar. A value of similarity can be established. In another embodiment, the value of similarity can be predefined by a recruiter. For example, one recruiter can establish a high value of similarity if the recruiter only wants to view recommended jobseekers that have very close affinity to those jobseeker listings that the recruiter has previously viewed or selected. Likewise, another recruiter can establish a low value of similarity if the recruiter wants to view recommended jobseekers that are loosely related to those job listings that the recruiter has previously viewed or selected. In yet another embodiment, the value of similarity can be predefined according to the attributes being compared.

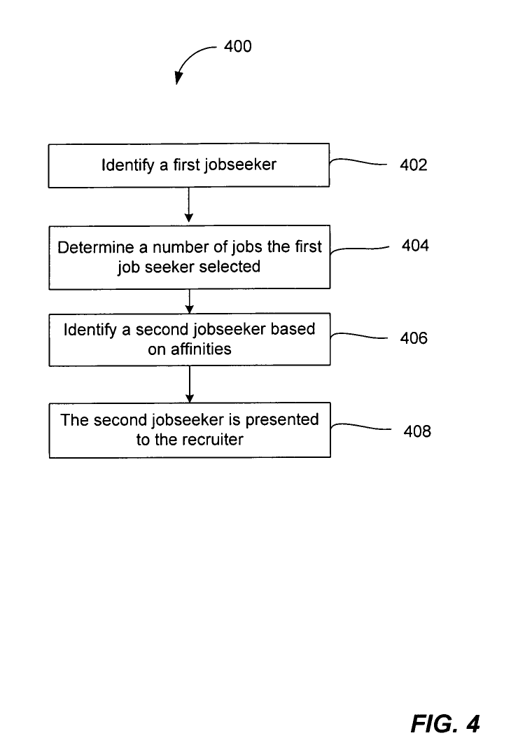

FIG. 4 illustrates a flow diagram for a process of 400 determining jobseeker affinity between two jobseekers. The affinity between two jobseekers can be determined by the number of jobs for which more than one jobseeker has applied and/or viewed in common.

At process block 402, a first jobseeker is identified to be a good fit for a particular job. A recruiter has determined that this job candidate is a suitable fit and for a particular job and the recruiter would like to search for similar candidates. The process 400 continues to process block 404.

At process block 404, the jobs selected by the first jobseeker are retrieved from the database 120 by the affinity module 108 to determine other jobseekers that are selected for jobs in common with the first jobseeker. In one embodiment, the word “selected” means that the jobseekers applied for a particular job listing. In another embodiment, the word “selected” means that the jobseekers viewed a particular job listing. In yet another embodiment, the word “selected” means that the jobseekers rated a first job listing and a second job listing. Thus, a jobseeker is deemed selected based upon a flexible or application-specific variety of user interaction events.

The process 400 continues to process block 406. At process block 406, a second jobseeker is determined to be another good job candidate due to having selected a number of jobs in common with the first jobseeker. An affinity between the first jobseeker and the second jobseeker is determined. In one example, the affinity between the first jobseeker and the second jobseeker is the number of selections both the first jobseeker and the second jobseeker had in common. In another example, the affinity between the first jobseeker and the second jobseeker is a number proportional to the number of jobs for which both the first jobseeker and the second jobseeker applied and viewed, wherein the jobs viewed may be of a different, lesser weight than the weight given to having applied for the same job. The process 400 continues to process block 408.

At process block 408, the results of the jobseeker search results that include the information of the second job candidate is presented to the recruiter.

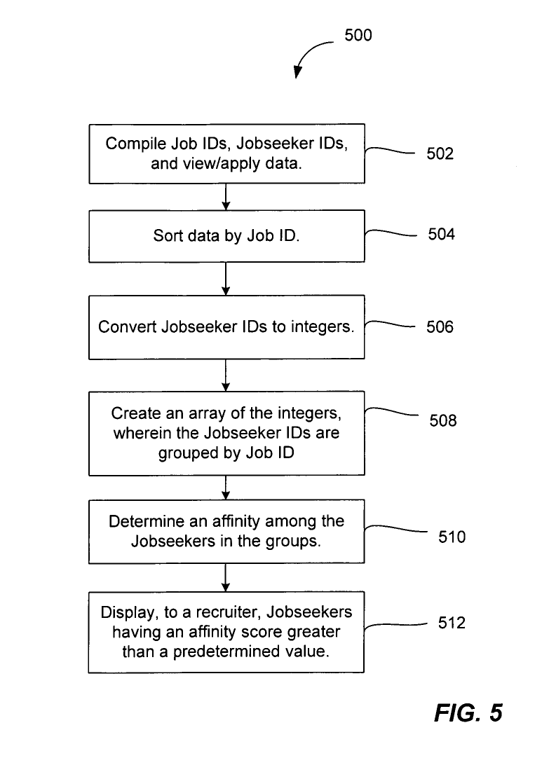

FIG. 5 illustrates a flow diagram for a process 500 of determining jobseeker affinity among jobseekers from collected jobseeker data. At process block 502, jobseeker activity is monitored with respect to job listings displayed on a web site, provided by job listing provider 112, in response to a query by a jobseeker. The monitored jobseeker activity includes jobs viewed by the jobseeker and jobs applied for by the jobseeker. Each jobseeker is assigned a jobseeker ID by which the server 104 correlates a job ID in the database 120 for each job for which the jobseeker applies and for each job for which the jobseeker does not apply, but only views. The process 500 continues to process block 504.

At process block 504, a list of job IDs is obtained from the database 120 with corresponding jobseeker IDs of jobseekers having applied for or viewed at least one job among the list of job IDs. The process 500 continues to process block 506.

At process block 506, the list is sorted by job ID. The process 500 continues to process block 508. At process block 508, the jobseeker IDs are converted to integers. The process 500 continues to process block 510.

At process block 510, the integers are grouped by job IDs. By grouping the integers it is easy to determine in which groups each jobseeker is located. The process 500 continues to process block 512.

At process block 512, an affinity is determined among jobseekers in each group according to the formula:

$$S = \frac{{N}_{12}}{( {N}_{1} ) ( {N}_{2} )}$$

Where S is an affinity score, N₁₂ is a total number of jobs for which two jobseekers individually applied, N₁ is a total number of jobs for which a first jobseeker applied, and N₂ is a total number of jobs for which a second jobseeker applied. In one example, jobs viewed would also be included in calculating N₁₂, N₁ and N₂. In another example the jobs viewed would be weighted less than the jobs applied for in determining N₁₂, N₁ and N₂. The process 500 continues to process block 514.

At process block 514, jobseekers having an affinity score greater than a predetermined value are displayed to a recruiter, concluding process flow operations.

As an illustrative example, data associated with jobseeker activity on a job listing provider 112 is collected and stored in a database. The data, pre-sorted, for two jobseekers and two jobs collected by the system may appear as follows:

| | | |
|---|---|---|
| job1 | jobseeker1 | a |
| job2 | jobseeker1 | a |
| job1 | jobseeker2 | v |
| job2 | jobseeker2 | v |

Wherein “a” stands for “apply” and “v” stands for “view.” “Apply” means that the jobseeker applied for this job and “view” means that the jobseeker viewed the details of this job but did not apply.

After sorting the data:

| | | |
|---|---|---|
| job1 | jobseeker1 | a |
| job1 | jobseeker2 | v |
| job2 | jobseeker1 | a |
| job2 | jobseeker2 | v |

In order to save memory and disk space the jobseekers are converted into integers. The data would then appear as follows:

| | | |
|---|---|---|
| job1 | 1 | a |
| job1 | 2 | v |
| job2 | 1 | a |
| job2 | 2 | v |

Wherein Jobseeker1 is represented by the integer 1 and Jobseeker2 is represented by the integer 2.

A list is then created that maps the jobseeker id to an integer and determines which and for how many jobs each jobseeker applied and/or viewed. Such a list may appear as follows:

| | | | |
|---|---|---|---|
| Jobseeker1 | 1 | 2 | 0 |
| Jobseeker2 | 2 | 1 | 1 |

From above, we know that jobseeker1 is mapped to integer 1 and he/she applied to 2 jobs and viewed 0 jobs. Jobseeker2 is mapped to integer 2 and he/she applied to 1 job and viewed 1 job. This data will be used to calculate the affinity scores when the integers are mapped back to the jobseeker IDs.

An array of the above data is then created. The array includes job data for all of the jobseekers. The array for two jobseekers and two jobs may appear as follows:
[1,−1,0,1,−1]

In the array above, 0 is used to divide the integers (jobseekers) into different groups. Each group represents a set of jobseekers who applied for or viewed the same job. In this example, the minus sign represents a job that the jobseeker “viewed;” otherwise he/she “applied” for the job. Therefore, 1 (jobseeker1) applied to job1 and job2 and 2 (jobseeker2) viewed job1 and job2 (because of the minus sign). In calculating the affinity, to what job a group applied or viewed is not important because the job acts as a link between jobseekers. That is why the array does not include job information.

A file is created that contains the starting positions of each group in the array of which each jobseeker is a part. For example:

| | | |
|---|---|---|
| 1 | 0 | 3 |
| 2 | 0 | 3 |

From the data above, we can see that jobseeker 1 (integer 1) and jobseeker 2 are in the groups starting from position 0 and position 3 in the array (note that the first position is denoted by 0).

An affinity is then calculated based on above data structure. The formula used to calculate the affinity score between jobseeker1 and jobseeker2 is:

$$S = \frac{{N}_{12}}{( {N}_{1} ) ( {N}_{2} )}$$

Where S is the affinity score, N₁₂ is the total number of jobs to which jobseeker1 and jobseeker2 both applied, N₁ is the total number of jobs to which jobseeker1 applied and N₂ is the total number of jobs to which jobseeker2 applied.

In one instance, jobs viewed would count in the calculation with different weights being applied (less than or equal to 1) to the viewed data and the applied-for data because having applied for a job means that the job is more relevant to a jobseeker than a job the jobseeker simply viewed. Therefore, having applied for a job would be given more weight than having viewed a job in determining the affinities. Alternatively, the applied for and viewed data may have identical weights. Taking viewed data into account, N₁₂ would be total number of jobs to which jobseeker1 and jobseeker2 both individually applied plus the total number of jobs that jobseeker1 and jobseeker2 both individually viewed and N₁ would be the total number of jobs for which jobseeker1 applied and viewed and N₂ would be the total number of jobs for which jobseeker2 applied and viewed.

Now for each jobseeker, we can obtain the location of each jobseeker within the groups.

Referring to the file created above:

| | | |
|---|---|---|
| 1 | 0 | 3 |
| 2 | 0 | 3 |

The first number corresponds to a jobseeker. The following numbers are the starting positions of groups in the array in which each jobseeker is located. For example, in the first line, Jobseeker1 (integer 1) belongs to the groups starting from position 0 and 3. To obtain all recommendations for jobseeker1, we first go to the group starting from position 0 and get all jobseekers located in this group. Each jobseeker has either “applied for” or “viewed” the job corresponding to the group of position 0. For simplicity in this example, the views are weighted the same as the applies. For each jobseeker in the group, add 1 to the total number for this jobseeker (for N₁₂ defined above). Add 1 to the total number for jobseeker2—now the total is 1 (N₁₂=1 for now). Go to next group (starting from 3), we find jobseeker2 again, so add 1 to the total. Now N₁₂ becomes 2. We have already calculated the total applies/views for each jobseeker. Therefore, the affinity between jobseeker1 and jobseeker2 is calculated as follows: total jobs for which jobseeker1 applied or viewed is 2 and total jobs for which jobseeker2 applied or viewed is 2, and total jobs for which both of them applied or viewed is 2, so,

Affinity=2/2*2=0.5

Looping through the file will get all the affinities for all the jobseekers.

In another, more complex, illustrative example, expanding the number of jobseekers, the data associated with jobseeker activity on a job listing provider 112 is collected and stored in a database. The data, pre-sorted, for multiple jobseekers and multiple jobs collected by the system may appear as follows:

| | | |
|---|---|---|
| job1 | jobseeker1 | a |
| job2 | jobseeker1 | a |
| job1 | jobseeker2 | v |
| job2 | jobseeker2 | v |
| job3 | jobseeker1 | a |
| job3 | jobseeker2 | a |
| job3 | jobseeker3 | a |
| job4 | jobseeker1 | a |
| job4 | jobseeker2 | v |
| job4 | jobseeker3 | a |
| job4 | jobseeker4 | a |
| job1 | jobseeker4 | v |
| job1 | jobseeker3 | a |
| job5 | jobseeker2 | a |
| job5 | jobseeker3 | a |
| job5 | jobseeker1 | v |

Wherein the character “a” stands represents a job that a jobseeker “applied for” and “v” represents a job that a jobseeker “viewed” where the jobseeker viewed the details of this job but not applied.

The data is then sorted by job ID:

| | | |
|---|---|---|
| job1 | jobseeker1 | a |
| job1 | jobseeker2 | v |
| job1 | jobseeker3 | a |
| job1 | jobseeker4 | v |
| job2 | jobseeker1 | a |
| job2 | jobseeker2 | v |
| job3 | jobseeker1 | a |
| job3 | jobseeker2 | a |
| job3 | jobseeker3 | a |
| job4 | jobseeker1 | a |
| job4 | jobseeker2 | v |
| job4 | jobseeker3 | a |
| job4 | jobseeker4 | a |
| job5 | jobseeker1 | a |
| job5 | jobseeker2 | a |
| job5 | jobseeker3 | v |

In order to save memory and disk space the jobseekers are converted into integers. The data would then appear as follows:

| | | |
|---|---|---|
| job1 | 1 | a |
| job1 | 2 | v |
| job1 | 3 | a |
| job1 | 4 | v |
| job2 | 1 | a |
| job2 | 2 | v |
| job3 | 1 | a |
| job3 | 2 | a |
| job3 | 3 | a |
| job4 | 1 | a |
| job4 | 2 | v |
| job4 | 3 | a |
| job4 | 4 | a |
| job5 | 1 | a |
| job5 | 2 | a |
| job5 | 3 | v |

Next, a list is created that maps the jobseeker ID to an integer making it possible to easily determine how many jobs each jobseeker applied for and viewed:

| | | | |
|---|---|---|---|
| Jobseeker1 | 1 | 4 | 1 |
| Jobseeker2 | 2 | 2 | 3 |
| Jobseeker3 | 3 | 3 | 0 |
| Jobseeker4 | 4 | 1 | 1 |

In the above list, jobseeker1 is mapped to integer 1 and he/she applied to 4 jobs and viewed 1 job. Jobseeker2 is mapped to integer 2 and he/she applied to 2 jobs and viewed 3 jobs. Jobseeker3 is mapped to integer 3 and he/she applied to 3 jobs and viewed 0 jobs. Jobseeker4 is mapped to integer 4 and he/she applied to 1 job and viewed 1 job.

An array of the data is then created.

| | | |
|---|---|---|
| job1 | 1 | a |
| job1 | 2 | v |
| job1 | 3 | a |
| job1 | 4 | v |
| job2 | 1 | a |
| job2 | 2 | v |
| job3 | 1 | a |
| job3 | 2 | a |
| job3 | 3 | a |
| job4 | 1 | a |
| job4 | 2 | v |
| job4 | 3 | a |
| job4 | 4 | a |
| job5 | 2 | a |
| job5 | 3 | a |
| job5 | 1 | v |

[1, −2, 3, −4, 0, 1, −2, 0, 1, 2, 3, 0, 1, −2, 3, 4, 0, −1, 2, 3]

Note that in the array above, 0 is used to divide integers (jobseekers) into different groups. Each group represents a set of jobseekers who applied to or viewed the same job; different groups applied to or viewed different jobs. The minus sign implies that the jobseeker “viewed” the job; otherwise he/she “applied” to the job. In the example above, 1 (jobseeker1) applied to job1 and 2 (jobseeker2) viewed job1 (because 2 has a minus sign), and the same two jobseekers also applied to or viewed job2. In the actual calculation, to what job a group applied or viewed is not important because the job only acts as a link between jobseekers. That is why in the array we don't have any job information.

In this step, we also create a file that contains the starting positions of the groups in the array to which each jobseeker belongs:

| | | | | | |
|---|---|---|---|---|---|
| 1 | 0 | 5 | 8 | 12 | 17 |
| 2 | 0 | 5 | 8 | 12 | 17 |
| 3 | 0 | 8 | 12 | 17 | |
| 4 | 0 | 12 | | | |

From the data above, we can see that jobseeker 1 (integer 1) and jobseeker 2 are in the groups starting from position 0, 5, 8, 12 and 17 in the array (note that the first position is denoted by 0).

Using the above data structure, an affinity among jobseekers can be determined using the equation:

$$S = \frac{{N}_{12}}{( {N}_{1} ) ( {N}_{2} )}$$

Where S is an affinity score, N₁₂ is a total number of jobs for which two jobseekers individually applied, N₁ is a total number of jobs for which a first of the two jobseeker applied, and N₂ is a total number of jobs for which a second jobseeker applied. The jobseeker results are displayed to a recruiter, each having an affinity score with another jobseeker greater than a predetermined value.

In one instance, jobs “viewed” are also taken into account. In such an instance, N₁₂ would be the total number of jobs for which jobseeker1 and jobseeker2 both individually applied plus the total number of jobs that jobseeker1 and jobseeker2 both individually viewed, N₁ would be the total number of jobs for which jobseeker1 applied plus the total number of jobs viewed and N₂ would be the total number of jobs for which jobseeker2 applied plus the total number of jobs viewed.

In another instance, jobs viewed would count in the calculation with different weights being applied (less than or equal to 1) to the viewed data and the applied-for data because having applied for a job means that the job is more relevant to a jobseeker than a job the jobseeker simply viewed. Therefore, having applied for a job would be given more weight in determining the affinities than having viewed a job. Alternatively, the applied-for and viewed data may have identical weights.

The above 5 jobs and 4 jobseekers yields the following:
Jobseeker 1 applied for 4 jobs and viewed 1.
Jobseeker 2 applied for 2 and viewed 3.
Jobseeker1 and jobseeker2 both applied for 1 of the same jobs.
Jobseekers 1 and 3 both applied for 3 jobs in common and both applied for 4 jobs.
Jobseekers 1 and 4: both applied for 1 job in common.

Using the equation to determine the affinities and assuming that views are weighted the same as applies:
S for jobseekers 1 and 2 would be 5/5*5=1/5.
S for jobseekers 1 and 3 would be 4/5*4=1/5.
S for jobseekers 1 and 4 would be 2/5*2=1/5.
S for jobseekers 3 and 4 would be 2/4*2=1/4.

Thus, for example, if a recruiter selects a job, namely Job 1, the recruiter can be recommended jobseeker2, jobseeker3, and jobseeker4, along with the number of other common jobseekers.

While the apparatus and method have been described in terms of what are presently considered the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. In addition, attributes utilized in some examples, the number of users or jobseekers, and other particular details are disclosed for discussion and exemplary purposes only. The present disclosure includes any and all embodiments of the following claims.

1. A method of establishing affinities among jobseekers, the method comprising:
monitoring jobseeker activity with respect to job listings displayed on a web site in response to a query by a jobseeker, wherein the activity includes jobs viewed by the jobseeker and jobs applied for by the jobseeker;
assigning a jobseeker ID to each jobseeker;
correlating for each jobseeker a job ID in a database for each job the jobseeker views and does not apply for;
correlating for each jobseeker a job ID in the database for each job for which the jobseeker applies;
obtaining from the database a list of job IDs with corresponding jobseeker IDs of jobseekers having applied for or viewed at least one job among the list of job IDs;
sorting the list by job ID;
converting the jobseeker IDs to integers;
grouping the list by job ID;
determining the group in which each jobseeker is located;
determining an affinity among jobseekers in the groups according to the formula:
$$S = \frac{{N}_{12}}{( {N}_{1} ) ( {N}_{2} )}$$
wherein S is an affinity score, N₁₂ is a total number of jobs for which two jobseekers individually applied, N₁ is a total number of jobs for which a first of the two jobseekers applied, and N₂ is a total number of jobs for which a second jobseeker applied; and
displaying to a recruiter jobseekers, each having an affinity score with another jobseeker greater than a predetermined value.

2. The method of claim 1, wherein the predetermined value is 0.5.

3. method of claim 1, wherein the predetermined value is adjustable by the recruiter.

4. A method of establishing affinities among jobseekers, the method comprising:
monitoring jobseeker activity with respect to job listings displayed on a web site in response to a query by a jobseeker, wherein the activity includes jobs viewed by the jobseeker and jobs applied for by the jobseeker;
assigning a jobseeker ID to each jobseeker;
correlating for each jobseeker a job ID in a database for each job for which the jobseeker views and does not apply;
correlating for each jobseeker a job ID in the database for each job for which the jobseeker applies;
obtaining from the database a list of job IDs with corresponding jobseeker IDs of jobseekers having applied for or viewed at least one job among the list of job IDs;
sorting the list by job ID;
converting the jobseeker IDs to integers, wherein the integer is positive for jobseekers having applied for the corresponding job and the integer is negative for jobseekers having viewed the corresponding job;
grouping the list by job ID;
determining the group in which each jobseeker is located;
determining an affinity among jobseekers in the groups according to the formula:
$$S = \frac{{N}_{12}}{( {N}_{1} ) ( {N}_{2} )}$$
wherein S is an affinity score, N₁₂ is a total number of jobs for which two jobseekers individually applied, N₁ is a total number of jobs for which a first of the two jobseekers applied, and N₂ is a total number of jobs for which a second jobseeker applied; and
displaying to a recruiter jobseekers, each having an affinity score with another jobseeker greater than a predetermined value.

5. The method of claim 4, wherein the predetermined value is 0.5.

6. The method of claim 4, wherein the predetermined value is adjustable by the recruiter.

7. A method of establishing affinities among jobseekers, the method comprising:
monitoring jobseeker activity with respect to job listings displayed on a web site in response to a query by a jobseeker, wherein the activity includes jobs viewed by the jobseeker and jobs applied for by the jobseeker;
assigning a jobseeker ID to each jobseeker;
correlating for each jobseeker a job ID in a database for each job the jobseeker views and does not apply for;
correlating for each jobseeker a job ID in the database for each job for which the jobseeker applies;
obtaining from the database a list of job IDs with corresponding jobseeker IDs of jobseekers having applied for or viewed at least one job among the list of job IDs;
sorting the list by job ID;
converting the jobseeker IDs to integers, wherein the integer is positive for jobseekers having applied for the corresponding job and the integer is negative for jobseekers having viewed the corresponding job;
grouping the list by job ID, wherein a zero separates each group;
determining the group in which each jobseeker is located;
determining an affinity among jobseekers in the groups according to the formula:
$$S = \frac{{N}_{12}}{( {N}_{1} ) ( {N}_{2} )}$$
wherein S is an affinity score, N₁₂ is a total number of jobs for which two jobseekers individually applied, N₁ is a total number of jobs for which a first of the two jobseekers applied, and N₂ is a total number of jobs for which a second jobseeker applied; and
displaying to a recruiter jobseekers, each having an affinity score with another jobseeker greater than a predetermined value.

8. The method of claim 7, wherein the jobs applied for and jobs viewed in determining the affinity score in the equation have different weights.

9. The method of claim 7, wherein the predetermined value is 0.5.

10. The method of claim 7, wherein the predetermined value is adjustable by the recruiter.
